(19) United States
(12) Patent Application Publication
(10) Pub. No.: US 2022/0081498 A1
(43) Pub. Date: Mar. 17, 2022

(54) Use of urethane methacrylate compounds in reactive resin compositions

(71) Applicant: Hilti Aktiengesellschaft, Schaan (LI)

(72) Inventors: Georg Nickerl, Diessen am Ammersee (DE); Beate Gnass, Gersthofen (DE); Jens Bunzen, Augsburg (DE)

(73) Assignee: Hilti Aktiengesellschaft, Schaan (LI)

(21) Appl. No.: 17/309,500

(22) PCT Filed: Nov. 27, 2019
(86) PCT No.: PCT/EP2019/082740

§ 371 Date: Jun. 2, 2021

(30) Foreign Application Priority Data
Dec. 18, 2018 (EP) 18213339.7

(51) Int. Cl. C08F 20/10; C08K 3/34

(52) U.S. Cl. CPC C08F 20/10; C09D 5/004; C08K 3/34

(57) ABSTRACT

Low-viscosity urethane methacrylate compounds can be used in a reactive resin component to improve the thixotropic properties of the reactive resin component and/or the afterflow behavior of a reactive resin system containing the reactive resin component.

The invention relates to low-viscosity urethane methacrylate compounds as backbone resins, in particular to the use thereof in reactive resin components for structural purposes, in particular chemical fastening, in order to improve the thixotropic properties and the afterflow behavior.

The currently used radically curable fastening compositions are based on unsaturated polyesters, vinyl ester urethane resins and epoxy acrylates. These are usually two-component reactive resin systems, one component containing the resin (“component (A)”) and the other component (“component (B)”) containing the hardener. Other constituents such as inorganic fillers and additives, accelerators, stabilizers and reactive diluents may be contained in one and/or the other component. Mixing the two components initiates curing of the mixed components. When the fastening compositions are used for fastening anchoring elements in boreholes, the curing takes place in the boreholes.

Such a fastening composition is known from DE 3940138 A1, for example. This describes fastening compositions based on cycloaliphatic group-carrying monomers which may additionally contain unsaturated polyester or vinyl ester resins. However, such fastening compositions have relatively high viscosities, which limits their use, especially for chemical fastening technology.

On construction sites, there may be relatively large temperature ranges of, for example, −25° C. to +45° C., depending on the season and/or geographical location. Therefore, the high viscosity of the curable fastening compositions described at the outset and their resulting thixotropic behavior can lead to problems during use. Heavy demands are therefore placed on the field of application, in particular application in different temperature ranges, of such fastening compositions.

On the one hand, in the low temperature range a sufficiently low viscosity of the composition should be ensured during ejection, so that the composition has a flow resistance that is not too high. This is to ensure that the compositions can be processed, for example, using a hand dispenser, e.g. injected into the borehole. In particular when using static mixers, a low viscosity is important for correctly mixing the two components.

On the other hand, the composition should be sufficiently thixotropic over the entire temperature range, so as to prevent the individual components from afterflowing after completion of the dispensing and so that the composition does not leak out of the borehole during overhead mounting.

Another problem caused by temperature fluctuations is that the radical chain polymerization does not take place consistently. The cured fastening composition thus has a fluctuating/irregular and often insufficient homogeneity, which is reflected in fluctuations of the load values and often also in generally low load values. For example, at temperatures below 20° C., an increase in viscosity may lead to premature solidification of the fastening composition. As a result, the turnover in the radical chain polymerization is much lower, which contributes to a reduction of the load values.

Since temperature fluctuations on the construction site cannot be avoided, there is still a need for two-component reactive resin systems which ensure homogeneity and the associated reproducibility of the load values both at high and at low temperatures.

In order to address the above-mentioned problems, the proportion of reactive diluents is increased in the fastening compositions found on the market, which ultimately leads to a reduction in the resin content in the composition. The proportion of reactive diluents is often at least 50%, based on the reactive resin.

However, the increase in the proportion of reactive diluents also leads to some disadvantages, which are particularly noticeable in the use of the fastening composition for fastening anchoring means in boreholes.

Another considerable disadvantage is that although the viscosity is lowered by the reactive diluents, so that the compositions can be applied manually by means of a dispenser, the rheological properties of the compositions such as the thixotropy, are adversely affected by the increased proportion of low-viscosity compounds. This is achieved for the products already on the market in which means for adjusting the rheology, such as thixotropic agents, are added to the composition, which are usually expensive and drive up the production costs.

Despite the use of thixotropic agents, the compositions of commercially available products tend to a so-called afterflowing. The compositions are contained in containers with a plurality of chambers, which contain the components of the pasty composition which is usually multicomponent and flowable, and in which containers the chambers are essentially formed by cartridges or film tubes. “Containers” include, for example, cartridges with one or more receiving spaces for one or more components of the single or multi-component composition to be dispensed, which are provided directly or, for example, in foil bags in the receiving spaces of the cartridge. The cartridges are generally made of hard plastic, thus they are also called hard cartridges. The term “container” also includes foil bags filled with one or more components of the single or multi-component composition to be dispensed, which are inserted into a separate receiving body arranged on the dispensing device, such as a cartridge holder.

Due to the manufacturing process, pasty compositions can be particularly compressed, which leads to a dynamic behavior of the entire system, consisting of composition, container and dispenser.

When discharging the compositions, the dispensing process takes place intermittently, i.e. stroke by stroke. At the beginning of the dispensing operation, i.e. at the beginning of the dispensing stroke, the compositions in the cartridge chambers or the foil bags are first compressed due to their compressibility until the pressure in the cartridge chambers or foil bags is so large that the compositions begin to flow out. Once this point has been reached and the dispensing movement continues, the masses flow in the planned mixing ratio from the cartridge chambers or foil bags and are fed to a mixing element, such as a static mixer. At the end of the dispensing stroke, the system expands until the pressure in the cartridge chambers or the foil bags has dropped so far that a flow of the masses no longer takes place (also called relaxation phase). In this relaxation phase, a flow of the compositions is still observed, although no more stroke movement takes place, the so-called afterflowing.

There is therefore a need for reactive resin components whose rheological properties, in particular the thixotropy, are not adversely affected despite the reduced viscosity. Furthermore, there is a need for reactive resin systems which show improved afterflow behavior, that is, reduced afterflowing.

An object of the present invention is to influence the properties of a reactive resin component, which is due solely to the structure of the backbone resin, but not to the presence of additional compounds such as additives. The object of the present invention is principally to control the rheological properties of a two- or multi-component reactive resin system by means of the containing backbone resin. In particular, it is the object of the present invention to provide reactive resin components for two-component or multi-component reactive resin systems which, in addition to a low viscosity, have improved thixotropy and which have a significantly improved afterflow behavior of the compositions during dispensing.

These objects are achieved by means of the use according to claim 1.

The invention is based on the finding that it is possible to replace the resins previously used in fastening compositions with smaller, low-viscosity backbone resins, in order to reduce the viscosity and thus the dispensing forces of a fastening composition, more precisely of a reactive resin component, but without negatively influencing the rheological properties of the composition.

Surprisingly, it has been found that by using the low-viscosity backbone resins described herein, it is possible to provide a reactive resin component which, despite its low viscosity, has beneficial rheological properties over reactive resin components containing similar low viscosity backbone resins. This is reflected in an improved thixotropy, so that even without the additional use of additives, such as thixotropic agents, the reactive resin components do not flow out of the borehole and afterflow less when the composition is dispensed.

For better understanding of the invention, the following explanations of the method of producing a reactive resin and the terminology used herein are considered to be useful.

The preparation method for a reactive resin, as illustrated here using the example of a xylylene-based urethane methacrylate, typically occurs as follows:

1. Preparation of the Backbone Resin/Reactive Resin Master Batch

Xylylene diisocyanate and hydroxypropyl methacrylate (HPMA) are reacted in the presence of a catalyst and at least one inhibitor (which serves to stabilize the backbone resin formed by the polymerization, often called a stabilizer or process stabilizer). The backbone resin was created hereby.

The reaction mixture obtained after completion of the reaction is referred to as a reactive resin master batch. This is not further processed, i.e. the backbone resin is not isolated.

2. Preparation of the Reactive Resin After completion of the reaction to form the backbone resin, an accelerator-inhibitor system, i.e. a combination of one or more additional inhibitors and one or more accelerators and optionally at least one reactive diluent, are added to the reactive resin master batch.

Thereby the reactive resin is obtained.

The accelerator-inhibitor system serves to set the reactivity of the reactive resin, i.e. to set the time by which the reactive resin is not fully cured after addition of an initiator and, therefore, by which time a dowel mass mixed with the reactive resin remains processable after mixing with the initiator.

The inhibitor in the accelerator-inhibitor system may be the same as the inhibitor in the preparation of the backbone resin, if it is also capable of setting the reactivity, or another inhibitor, if it does not have both functions. 4-hydroxy-2,2,6,6-tetramethyl-piperidinyl-1-oxyl (TEMPOL) for example may be used for setting the reactivity as a stabilizer and as an inhibitor.

3. Preparation of the Reactive Resin Component

In order to use the reactive resin for construction purposes, in particular for chemical fastening, one or more inorganic additional substances, such as additives and/or fillers, are added after the preparation of the reactive resin.

As a result, the reactive resin component is obtained.

Within the meaning of the invention:
“backbone resin” means atypically solid or high-viscosity radically polymerizable resin which cures by polymerization (e.g. after addition of an initiator in the presence of an accelerator) and is usually present without reactive diluents and without further purification and thus may contain impurities;
“reactive resin master batch” means the reaction product of the reaction for producing the backbone resin, i.e. a mixture of backbone resin, reactive diluents and optionally other constituents of the reaction mixture;
“reactive resin” means a mixture of a reactive resin master batch, at least one accelerator and at least one inhibitor (also referred to as an accelerator-inhibitor system), at least one reactive diluent and optionally further additives; the reactive resin is typically liquid or viscous and can be further processed to form a reactive resin component; the reactive resin is also referred to herein as a “resin mixture”;
“inhibitor” means a substance which suppresses unwanted radical polymerization during the synthesis or storage of a resin or a resin-containing composition (these substances are also referred to in the art as “stabilizers”) or which delays the radical polymerization of a resin after addition of a initiator, usually in conjunction with an accelerator (these substances are also referred to in the art as “inhibitors”—the meaning of each term is apparent from the context);
“accelerator” means a reagent which reacts with the initiator so that larger quantities of free radicals are produced by the initiator even at low temperatures, or which catalyzes the decomposition reaction of the initiator;
“reactive diluents” means liquid or low-viscosity monomers and backbone resins which dilute other backbone resins or the reactive resin master batch and thereby impart the viscosity necessary for application thereof, which contain functional groups capable of reacting with the backbone resin, and which for the most part become a constituent of the cured composition (e.g. of the mortar) in the polymerization (curing); reactive diluents are also referred to as co-polymerizable monomers;
“reactive resin component” means a liquid or viscous mixture of reactive resin and fillers and optionally further components, e.g. additives; typically, the reactive resin component is one of the two components of a two-component reactive resin system for chemical fastening;
“initiator” means a substance which (usually in combination with an accelerator) forms reaction-initiating radicals;
“hardener component” means a composition containing an initiator for the polymerization of a backbone resin; the hardener component may be solid or liquid and may contain, in addition to the initiator, a solvent and fillers and/or additives; typically the hardener component, in addition to the reactive resin component, is the other of the two components of a two-component reactive resin chemical fastening system;
“mortar composition/fastening composition” means the composition which is obtained by mixing the reactive resin component with the hardener component and can be used as such directly for chemical fastening;
“reactive resin system” generally means a system comprising components stored separately from one another such that the backbone resin contained in a component is cured only after the components are mixed;
“two-component system” or “two-component reactive resin system” means a reactive resin system comprising two separately stored components, a reactive resin component (A) and a hardener component (B), so that a curing of the backbone resin contained in the reactive resin component takes place after the mixing of the two components;
“multi-component system” or “multi-component reactive resin system” means a reactive resin system comprising a plurality of separately stored components, including a reactive resin component (A) and a hardener component (B), so that curing of the backbone resin contained in the reactive resin component takes place after the mixing of all components;
“construction purposes” means any use for the construction and maintenance or repair of components and structures, as polymer concrete, as a resin-based coating composition or as a cold-curing road marking; in particular, the reinforcement of components and structures, such as walls, ceilings or floors, the fastening of components, such as slabs or blocks, e.g. made of stone, glass or plastics material, on components or structures, for example by bonding (structural bonding) and very particularly the chemical fastening of anchoring means, such as anchor rods, bolts or the like in recesses, such as boreholes;
“chemical fastening” means (non-positive and/or positive) fastening of anchoring means, such as anchor rods, bolts, rebar, screws or the like, in recesses, such as boreholes, in particular in boreholes in various substrates, in particular mineral substrates such as those based on concrete, aerated concrete, brickwork, limestone, sandstone, natural stone, glass and the like, and metal substrates such as steel;
“rheology” is the science that deals with the deformation and flow behavior of matter under the influence of a mechanical force;
“thixotropy” means in rheology a time dependence of the flow properties of non-Newtonian fluids, in which the viscosity decreases or increases due to persistent external influences and returns to the initial viscosity only after completion of stress;
“aliphatic hydrocarbon group” means an acyclic and cyclic, saturated or unsaturated hydrocarbon group that are not aromatic (PAC, 1995, 67, 1307; Glossary of class names of organic compounds and reactivity intermediates based on structure (IUPAC Recommendations 1995));
“aromatic hydrocarbon group” means a cyclic, planar hydrocarbon group having an aromatic system, which group, due to its delocalized electron system, is more energetically favorable than its non-aromatic mesomers and therefore is more chemically stable (PAC, 1995, 67, 1307; Glossary of class names of organic compounds and reactivity intermediates based on structure (IUPAC Recommendations 1995) page 1319);
“aromatic-aliphatic hydrocarbon group,” also “araliphatic hydrocarbon group” means a hydrocarbon group having an aromatic hydrocarbon group to which one or more aliphatic hydrocarbon group(s) is bonded, the aliphatic hydrocarbon group serving as a bridge to a functional group, so that the functional group is not bonded directly to the aromatic hydrocarbon group;
“aliphatic hydrocarbon group” means an acyclic and cyclic, saturated or unsaturated hydrocarbon group that are not aromatic (PAC, 1995, 67, 1307; Glossary of class names of organic compounds and reactivity intermediates based on structure (IUPAC Recommendations 1995));
“cycloaliphatic hydrocarbon group” means a group of cyclic, saturated hydrocarbons, which rings may carry side chains; they are counted among the alicyclic compounds; these include, in particular, monocyclic hydrocarbons, the term also being intended to include di- or higher-cyclic hydrocarbons;
“aromatic diisocyanate” means a compound in which the two isocyanate groups are bonded directly to an aromatic hydrocarbon skeleton;
“aromatic-aliphatic diisocyanate,” also “araliphatic diisocyanate” is a diisocyanate in which the two isocyanate groups are not directly bonded to an aromatic hydrocarbon skeleton but rather to the alkylene groups bonded to the aromatic hydrocarbon skeleton such that the alkylene group acts as a linker between the aromatic hydrocarbon skeleton and each of the isocyanate group;
“(meth)acrylic . . . / . . . (meth)acrylic . . . ” means both the “methacrylic . . . / . . . methacrylic” and the “acrylic . . . / . . . acrylic . . . ” compounds; “methacrylic . . . / . . . methacrylic” compounds are preferred in the present invention;
“a,” “an,” “any,” as the indefinite article preceding a class of chemical compounds, e.g. preceding the word “urethane methacrylate,” means that at least one, i.e. one or more compounds included under this class of chemical compounds, e.g. various urethane methacrylates, may be intended. In a preferred embodiment, this article means only a single compound;
“at least one” means numerically “one or more.” In a preferred embodiment, the term means numerically “one”;
“contain” and “comprise” mean that further constituents may be present in addition to those mentioned. These terms are intended to be inclusive and therefore encompass “consist of.” “Consist of” is intended to be exclusive and means that no further constituents may be present. In a preferred embodiment, the terms “contain” and “comprise” mean the term “consist of”;
“approximately” before a numerical value means a range of ±5% of this value, preferably ±2% of this value, more preferably ±1% of this value, particularly preferably ±0% of this value (i.e. exactly this value);
a range limited by numbers means that the two extreme values and any value within this range are disclosed individually.

All standards cited in this text (e.g. DIN standards) were used in the version that was current on the filing date of this application.

A first object of the invention is the use of a compound of general formula (I)

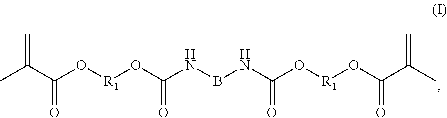

where B is
   (i) a divalent aromatic hydrocarbon group,
   (ii) a divalent aromatic-aliphatic hydrocarbon group, or
   (iii) a divalent linear, branched or cyclic aliphatic hydrocarbon group or an aliphatic hydrocarbon group comprising a cycloaliphatic moiety, and
   each R₁ is independently a branched or linear aliphatic C₁-C₁₅ alkylene group,

in a reactive resin component for chemical fastening to improve the thixotropic properties of the reactive resin component and/or the afterflow behavior of a reactive resin system comprising the reactive resin component.

(i) Divalent Aromatic Hydrocarbon Group

The hydrocarbon group B may be a divalent aromatic hydrocarbon group, preferably a C₆-C₂₀ hydrocarbon group and more preferably a C₆-C₁₄ hydrocarbon group. The aromatic hydrocarbon group may be substituted, in particular by alkyl groups, of which alkyl groups having one to four carbon atoms are preferred.

In one embodiment, the aromatic hydrocarbon group contains a benzene ring which may be substituted.

In an alternative embodiment, the aromatic hydrocarbon group contains two fused benzene rings or two benzene rings bridged over an alkylene group, such as a methylene or ethylene group, of which two benzene rings bridged via an alkylene group, such as a methylene or ethylene group, are preferred. Both the benzene rings and the alkylene bridge may be substituted, preferably with alkyl groups.

The aromatic hydrocarbon group is derived from aromatic diisocyanates. “aromatic diisocyanate” meaning that the two isocyanate groups are bonded directly to an aromatic hydrocarbon skeleton.

Suitable aromatic hydrocarbon groups are divalent groups as obtained by removing the isocyanate groups from an aromatic diisocyanate, for example a divalent phenylene group from a benzene diisocyanate, a methylphenylene group from a toluene diisocyanate (TDI) or an ethylphenylene group from an ethylbenzene diisocyanate, a divalent methylene diphenylene group from a methylene diphenyl diisocyanate (MDI) or a divalent naphthyl group from a naphthalene diisocyanate (NDI).

Particularly preferably, the aromatic hydrocarbon group is derived from 1,3-diisocyanatobenzene, 1,4-diisocyanatobenzene, 2,4-diisocyanatotoluene, 2,6-diisocyanatotoluene, 2,4′-diphenylmethane diisocyanate, 4,4′-diphenylmethane diisocyanate or 1,5-diisocyanatonaphthalene.

(ii) Divalent Aromatic-Aliphatic Hydrocarbon Group

The hydrocarbon group B may be a divalent aromatic-aliphatic hydrocarbon group, in particular a divalent aromatic-aliphatic hydrocarbon group Z of the formula (Z)

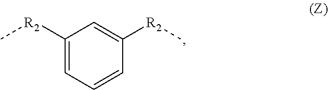

in which R₂ is a divalent branched or linear aliphatic C₁-C₆ alkylene group, preferably C₁-C₃ alkylene group.

The aromatic-aliphatic hydrocarbon group is derived from aromatic-aliphatic diisocyanates, “aromatic-aliphatic diisocyanate” meaning that the two isocyanate groups are not bonded directly to the aromatic nucleus, but to the alkylene groups.

Suitable aromatic-aliphatic hydrocarbon groups are divalent groups as obtained by removing the isocyanate groups from an aromatic-aliphatic diisocyanate, such as isomers of bis(1-isocyanato-1-methylethyl)-benzene and xylylene diisocyanate (bis-(isocyanatomethyl)benzene), preferably from 1,3-bis(1-isocyanato-1-methylethyl)-benzene or m-xylylene diisocyanate (1,3-bis-(isocyanatomethyl)benzene).

(ii) Divalent Linear, Branched or Cyclic Aliphatic Hydrocarbon Group

Alternatively, the hydrocarbon group B may be a divalent linear, branched or cyclic aliphatic hydrocarbon group, preferably selected from the group consisting of pentylene, hexylene, heptylene or octylene groups. Particularly preferably, in this embodiment the linear aliphatic hydrocarbon group B is a hexylene group.

In a further alternative embodiment, the hydrocarbon group B may be a divalent aliphatic hydrocarbon group which comprises a cycloaliphatic structural unit, in particular a hydrocarbon group of the formula (Y)

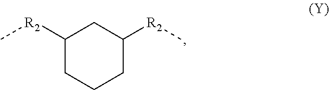

in which R₂ is a divalent branched or linear aliphatic C₁-C₆ alkylene group, preferably C₁-C₃ alkylene group, which is preferably selected from the group consisting of 3-methylene-3,5,5-tetramethylcyclohexylene, methylenedicyclohexylene and 1,3-dimethylenecyclohexyl groups. Particularly preferable, in this embodiment the cycloaliphatic hydrocarbon group is a 3-methylene-3,5,5-trimethylcyclohexylene or 1,3-dimethylencyclohexylene group.

The aliphatic hydrocarbon group is derived from aliphatic diisocyanates, which includes linear and branched aliphatic diisocyanates and cycloaliphatic diisocyanates.

Suitable aliphatic hydrocarbon groups are divalent groups as obtained by removing the isocyanate groups from an aliphatic diisocyanate.

Particularly preferably, the aliphatic hydrocarbon group is derived from aliphatic diisocyanates, such as 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′-and 4,4′-diisocyanatodicyclohexylmethane (H₁₂MDI), 1,3- and 1,4-bis(isocyanatomethyl)cyclohexane, bis-(isocyanatomethyl)-norbornane (NBDI), 4,4′-diisocyanato-3,3′-dimethyldicyclohexylmethane, 4,4′-diisocyanato-3.3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetra-methyl-1,1′-bi(cyclohexyl), 1,8-diisocyanato-p-menthane, 1,3-diisocyanato adamantane, 1,3-dimethyl-5,7-diisocyanato adamantane.

Each R₁ is independently a branched or linear aliphatic C₁-C₁₅ alkylene group which may be substituted. R₁ is derived from hydroxyalkyl methacrylates and comprises divalent alkylene groups as obtained by removing the hydroxyl groups and the methacrylate group.

In one embodiment, the alkylene group R₁ is divalent.

In an alternative embodiment, however, it may also be trivalent or have a higher valency, so that the compound of formula (I) may also have more than two methacrylate groups, even if this is not directly apparent from formula (I).

The alkylene group R₁ is preferably a divalent linear or branched C₁-C₁₅ alkylene group, preferably a C₁-C₆ alkylene group and particularly preferably a C₁-C₄ alkylene group.

These include in particular the methylene, ethylene, propylene, i-propylene, n-butylene, 2-butylene, sec-butylene, tert-butylene, n-pentylene, 2-pentylene, 2-methylbutylene, 3-methylbutylene, 1,2-dimethylpropylene, 1,1-dimethylpropylene, 2,2-dimethylpropylene, 1-ethylpropylene, n-hexylene, 2-hexylene, 2-methylpentylene, 3-methylpentylene, 4-methylpentylene, 1,2-dimethylbutylene, 1,3-dimethylbutylene, 2,3-dimethylbutylene, 1,1-dimethylbutylene, 2,2-dimethylbutylene, 3,3 dimethylbutylene, 1,1,2-trimethylpropylene, 1,2,2-trimethylpropylene, 1-ethylbutylene, 2-ethylbutylene, 1-ethyl-2-methylpropylene, n-heptylene, 2-heptylene, 3-heptylene, 2-ethylpentylene, 1-propylbutylene or octylene group, of which the ethylene, propylene and i-propylene group are more preferred. In a particularly preferred embodiment of the present invention, the two R₁ groups are identical and are an ethylene, propylene or i-propylene group.

Preparation of the Compounds of the Formula (I)

The low-viscosity urethane methacrylate compounds are obtained by reacting two equivalents of hydroxyalkyl methacrylate with at least one equivalent of diisocyanate. The diisocyanate and the hydroxyalkyl methacrylate are reacted in the presence of a catalyst and at least one inhibitor which serves to stabilize the formed compound.

Suitable hydroxyalkyl methacrylates are those having alkylene groups of one to 15 carbon atoms, where the alkylene groups may be linear or branched. Hydroxyalkyl methacrylates having one to 10 carbon atoms are preferred. Hydroxyalkyl methacrylates having two to six carbon atoms are more preferred, of which 2-hydroxyethyl methacrylate, 2-hydroxypropyl methacrylate (2-HPMA), 3-hydroxypropyl methacrylate (3-HPMA) and glycerol-1,3-dimethacrylate are particularly preferred, 2-hydroxypropyl methacrylate (2-HPMA) or 3-hydroxypropyl methacrylate (3-HPMA) are very particularly preferred.

Suitable aromatic diisocyanates are benzene diisocyanate, a methylphenylene group of a toluene diisocyanate (TDI) or an ethylphenylene group of an ethylbenzene diisocyanate, a divalent methylenediphenylene group of a methylene diphenyl diisocyanate (MDI) or a divalent naphthyl group of a naphthalene diisocyanate (NDI).

Particularly preferably, the aromatic hydrocarbon group is derived from 1,3-diisocyanatobenzene, 1,4-diisocyanatobenzene, 2,4-diisocyanatotoluene, 2,6-diisocyanatotoluene, 2,4′-diphenylmethane diisocyanate, 4,4′-diphenylmethane diisocyanate or 1,5-diisocyanatonaphthalene.

Suitable aromatic-aliphatic diisocyanates are those having a benzene ring as an alkyl-substituted aromatic nucleus and having aliphatically bonded isocyanate groups, i.e. the isocyanate group is bonded to the alkylene groups, such as isomers of bis(1-isocyanatoethyl)benzene, bis(2-isocyanatoethyl)benzene, bis(3-isocyanatopropyl)benzene, bis(1-isocyanato-1-methylethyl)-benzene and xylylene diisocyanate (bis-(isocyanatomethyl)benzene).

Preferred araliphatic diisocyanates are 1,3-bis(1-isocyanato-1-methylethyl)-benzene or m-xylylene diisocyanate (1,3-bis-(isocyanatomethyl)benzene).

Suitable aliphatic diisocyanates are: 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′-and 4,4′-diisocyanatodicyclohexylmethane (H₁₂MDI), 1,3- and 1,4-bis(isocyanatomethyl)cyclohexane, bis-(isocyanatomethyl)-norbornane (NBDI), 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetra-methyl-1,1′-bi(cyclohexyl), 1,8-diisocyanato-p-menthane, 1,3-diisocyanato adamantane, 1,3-dimethyl-5,7-diisocyanato adamantane.

Suitable aliphatic diisocyanates having a cycloaliphatic structural unit are: 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′-and 4,4′-diisocyanatodicyclohexylmethane (H₁₂MDI), 1,3- and 1,4-bis(isocyanatomethyl)cyclohexane, bis-(isocyanatomethyl)-norbornane (NBDI), 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetra-methyl-1,1′-bi(cyclohexyl), 1,8-diisocyanato-p-menthane, 1,3-diisocyanato adamantane, 1,3-dimethyl-5,7-diisocyanato adamantane.

The compound of the formula (I) is particularly preferably a compound of the general formula (II), (III) or (IV):

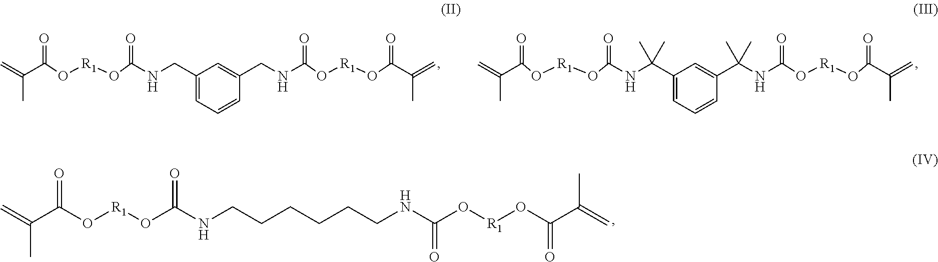

wherein each R₁ is independently defined as above.

Most preferably, the compound of formula (I) is a compound of formula (V), (VI) or (VII):

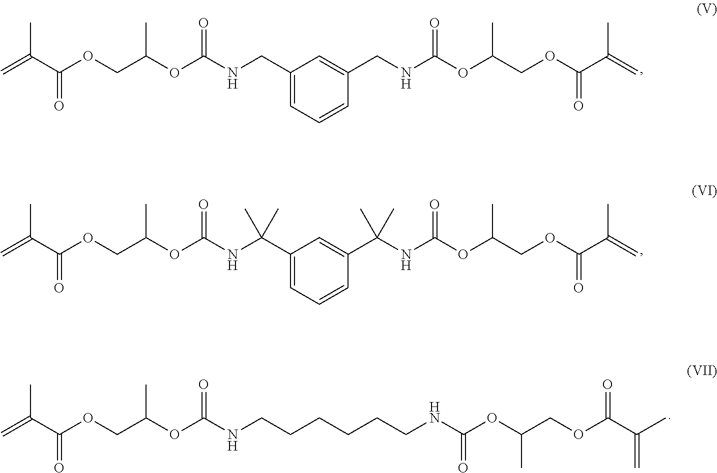

The structures shown in formulas (I) to (VII) are intended to represent the compounds according to the invention only by way of example, since the diisocyanates used for their preparation can be used both as isomerically pure compounds and as mixtures of different isomers, in each case having a different composition, i.e. in different proportions. The structures shown are therefore not to be interpreted as limiting.

Consequently, the compounds according to the invention may be present as isomerically pure compounds or as mixtures of isomers in different compositions, which can optionally be separated in a conventional manner. Both the pure isomers and the isomer mixtures are the subject of the present invention. Mixtures with different proportions of isomeric compounds are likewise the subject of the invention.

In the event that not all of the isocyanate groups are reacted in the preparation of the compounds according to the invention or some of the isocyanate groups are converted before the reaction into other groups, for example by a side reaction, compounds are obtained which may be contained either as main compounds or as impurities in the reaction resin master batches. These compounds, insofar as they can be used for the purposes according to the invention, are also encompassed by the invention.

The compounds of formula (I) are used to prepare a reactive resin component. According to the invention, the rheological properties, in particular the thixotropy of the reactive resin component, can thereby be positively influenced.

First, using the compound of the formula (I) as the above-described backbone resin, a reactive resin is prepared which contains, in addition to the compound of the formula (I), an inhibitor, an accelerator and optionally at least one reactive diluent. Since the backbone resin is typically used for the preparation of the reactive resin without isolation after the preparation thereof, the other constituents contained in the reactive resin master-batch in addition to the backbone resin are also usually present in the reactive resin, such as a catalyst.

The proportion of the compound of the general formula (I) in the reactive resin is from 25 wt. % to 65 wt. %, preferably from 30 wt. % to 60 wt. %, particularly preferably from 33 wt. % to 55 wt. %, based on the total weight of the reactive resin.

The stable radicals which are conventionally used for radically polymerizable compounds, such as N-oxyl radicals, are suitable as inhibitors, as are known to a person skilled in the art.

The inhibitor can serve to suppress unwanted radical polymerization during the synthesis of the backbone resin or the storage of the reactive resin and the reactive resin component. It may also serve—optionally additionally—to delay the radical polymerization of the backbone resin after addition of the initiator and thereby to adjust the processing time of the reactive resin or reactive resin component after mixing with the hardener.

Examples of stable N-oxyl radicals which can be used are those described in DE 199 56 509 A1 and DE 195 31 649 A1. Stable nitroxyl radicals of this kind are of the piperidinyl-N-oxyl or tetrahydropyrrole-N-oxyl type or a mixture thereof.

Preferred stable nitroxyl radicals are selected from the group consisting of 1-oxyl-2,2,6,6-tetramethylpiperidine, 1-oxyl-2,2,6,6-tetramethylpiperidin-4-ol (also referred to as TEMPOL), 1-oxyl-2,2,6,6-tetramethylpiperidin-4-one (also referred to as TEMPON), 1-oxyl-2,2,6,6-tetramethyl-4-carboxyl-piperidine (also referred to as 4-carboxy-TEMPO), 1-oxyl-2,2,5,5-tetramethylpyrrolidine, 1-oxyl-2,2,5,5-tetramethyl-3-carboxylpyrrolidine (also referred to as 3-carboxy-PROXYL) and mixtures of two or more of these compounds, 1-oxyl-2,2,6,6-tetramethylpiperidin-4-ol (TEMPOL) being particularly preferred. The TEMPOL is preferably the TEMPOL used in the examples.

In addition to the nitroxyl radical of the piperidinyl-N-oxyl or tetrahydropyrrole-N-oxyl type, one or more further inhibitors may be present both to further stabilize the reactive resin or the reactive resin component (A) containing the reactive resin or other compositions containing the reactive resin and to adjust the resin reactivity.

For this purpose, the inhibitors which are conventionally used for radically polymerizable compounds are suitable, as are known to a person skilled in the art. These further inhibitors are preferably selected from phenolic compounds and non-phenolic compounds and/or phenothiazines.

Phenols, such as 2-methoxyphenol, 4-methoxyphenol, 2,6-di-tert-butyl-4-methylphenol, 2,4-di-tert-butylphenol, 2,6-di-tert-butylphenol, 2,4,6-trimethylphenol, 2,4,6-tris(dimethylaminomethyl)phenol, 4,4′-thio-bis(3-methyl-6-tert-butylphenol), 4,4′-isopropylidenediphenol, 6,6′-di-tert-butyl-4,4′-bis(2,6-di-tert-butylphenol), 1,3,5-trimethyl-2,4,6-tris(3,5-di-tert-butyl-4-hydroxybenzyl)benzene, 2,2′-methylene-di-p-cresol, catechols such as pyrocatechol, and catechol derivatives such as butylpyrocatechols such as 4-tert-butylpyrocatechol and 4,6-di-tert-butylpyrocatechol, hydroquinones such as hydroquinone, 2-methylhydroquinone, 2-tert-butylhydroquinone, 2,5-di-tert-butylhydroquinone, 2,6-di-tert-butylhydroquinone, 2,6-dimethylhydroquinone, 2,3,5-trimethylhydroquinone, benzoquinone, 2,3,5,6-tetrachloro-1,4-benzoquinone, methylbenzoquinone, 2,6-dimethylbenzoquinone, naphthoquinone, or mixtures of two or more thereof, are suitable as phenolic inhibitors. These inhibitors are often a constituent of commercial radically curing reactive resin components.

Phenothiazines such as phenothiazine and/or derivatives or combinations thereof, or stable organic radicals such as galvinoxyl and N-oxyl radicals, but not of the piperidinyl-N-oxyl or tetrahydropyrrole-N-oxyl type, are preferably considered as non-phenolic inhibitors, such as aluminum-N-nitrosophenylhydroxylamine, diethylhydroxylamine, oximes such as acetaldoxime, acetone oxime, methyl ethyl ketoxime, salicyloxime, benzoxime, glyoximes, dimethylglyoxime, acetone-O-(benzyloxycarbonyl)oxime, and the like.

Furthermore, pyrimidinol or pyridinol compounds substituted in para-position to the hydroxyl group, as described in the patent DE 10 2011 077 248 B1, can be used as inhibitors.

The further inhibitors are preferably selected from the group of catechols, catechol derivatives, phenothiazines, tert-butylcatechol, tempol, or a mixture of two or more thereof. Particularly preferably, the other inhibitors are selected from the group of catechols and phenothiazines. The further inhibitors used in the examples are very particularly preferred, preferably approximately in the amounts indicated in the examples.

The other inhibitors may be used either alone or as a combination of two or more thereof, depending on the desired properties of the reactive resin.

The inhibitor or inhibitor mixture is added in conventional amounts known in the art, preferably in an amount of approximately 0.0005 to approximately 2 wt. %, more preferably from approximately 0.01 to approximately 1 wt. %, even more preferably from approximately 0.05 to approximately 1 wt. %, yet more preferably from approximately 0.2 to approximately 0.5 wt. % based on the reactive resin.

The compounds of general formula (I), especially when used in reactive resins and reactive resin components for chemical fastening and structural bonding, are generally cured by peroxides as a hardener. The peroxides are preferably initiated by an accelerator, so that polymerization takes place even at low application temperatures. The accelerator is already added to the reactive resin.

Suitable accelerators which are known to the person skilled in the art are, for example, amines, preferably tertiary amines and/or metal salts.

Suitable amines are selected from the following compounds: dimethylamine, trimethylamine, ethylamine, diethylamine, triethylamine, n-propylamine, di-n-propylamine, tri-n-propylamine, isopropylamine, diisopropylamine, triisopropylamine, n-butylamine, isobutylamine, tert-butylamine, di-n-butylamine, diisobutylamine, triisobutylamine, pentylamine, isopentylamine, diisopentylamine, hexylamine, octylamine, dodecylamine, laurylamine, stearylamine, aminoethanol, diethanolamine, triethanolamine, aminohexanol, ethoxyaminoethane, dimethyl-(2-chloroethyl)amine, 2-ethylhexylamine, bis-(2-chloroethyl)amine, 2-ethylhexylamine, bis-(2-ethylhexyl)amine, N-methylstearylamine, dialkylamines, ethylenediamine, N,N′-dimethylethylenediamine, tetramethylethylenediamine, diethylenetriamine, permethyldiethylenetriamine, triethylenetetramine, tetraethylenepentamine, 1,2-diaminopropane, di-propylenetriamine, tripropylenetetramine, 1,4-diaminobutane, 1,6-diaminohexane, 4-amino-1-diethylaminopentane, 2,5-diamino-2,5-dimethylhexane, trimethylhexamethylenediamine, N,N-dimethylaminoethanol, 2-(2-diethylaminoethoxy)ethanol, bis-(2-hydroxyethyl)oleylamine, tris-[2-(2-hydroxyethoxy)ethyl]amine, 3-amino-1-propanol, methyl-(3-aminopropyl)ether, ethyl-(3-aminopropyl)ether, 1,4-butanediol-bis(3-aminopropyl ether), 3-dimethylamino-1-propanol, 1-amino-2-propanol, 1-diethylamino-2-propanol, diisopropanolamine, methyl-bis-(2-hydroxypropyl)amine, tris-(2-hydroxypropyl)amine, 4-amino-2-butanol, 2-amino-2-methylpropanol, 2-amino-2-methylpropanediol, 2-amino-2-hydroxymethylpropanediol, 5-aethylamino-2-pentanone, 3-methylaminopropionitrile, 6-aminohexanoic acid, 11-aminoundecanoic acid, 6-aminohexanoic acid ethyl ester, 11-aminohexanoate-isopropyl ester, cyclohexylamine, N-methylcyclohexylamine, N,N-dimethylcyclohexylamine, dicyclohexylamine, N-ethylcyclohexylamine, N-(2-hydroxyethyl)-cyclohexylamine, N,N-bis-(2-hydroxyethyl)-cyclohexylamine, N-(3-aminopropyl)-cyclohexylamine, aminomethylcyclohexane, hexahydrotoluidine, hexahydrobenzylamine, aniline, N-methylaniline, N,N-dimethylaniline, N,N-diethylaniline, N,N-di-propylaniline, iso-butylaniline, toluidine, diphenylamine, hydroxyethylaniline, bis-(hydroxyethyl)aniline, chloroaniline, aminophenols, aminobenzoic acids and esters thereof, benzylamine, dibenzylamine, tribenzylamine, methyldibenzylamine, α-phenylethylamine, xylidine, diisopropylaniline, dodecylaniline, aminonaphthalin, N-methylaminonaphthalin, N,N-dimethylaminonaphthalin, N,N-dibenzylnaphthalin, diaminocyclohexane, 4,4′-diamino-dicyclohexylmethane, diamino-dimethyl-dicyclohexylmethane, phenylenediamine, xylylenediamine, diaminobiphenyl, naphthalenediamines, toluidines, benzidines, 2,2-bis-(aminophenyl)-propane, aminoanisoles, amino-thiophenols, aminodiphenyl ethers, aminocresols, morpholine, N-methylmorpholine, N-phenylmorpholine, hydroxyethylmorpholine, N-methylpyrrolidine, pyrrolidine, piperidine, hydroxyethylpiperidine, pyrroles, pyridines, quinolines, indoles, indolenines, carbazoles, pyrazoles, imidazoles, thiazoles, pyrimidines, quinoxalines, aminomorpholine, dimorpholineethane, [2,2,2]-diazabicyclooctane and N,N-dimethyl-p-toluidine.

The accelerator used according to the invention is di-isopropanol-p-toluidine or N,N-bis(2-hydroxyethyl)-m-toluidine.

Preferred amines are aniline derivatives and N,N-bisalkylarylamines, such as N,N-dimethylaniline, N,N-diethylaniline, N,N-dimethyl-p-toluidine, N,N-bis(hydroxyalkyl)arylamines, N,N-bis(2-hydroxyethyl)aniline, N,N-bis(2-hydroxyethyl) toluidine, N,N-bis(2-hydroxypropyl)aniline, N,N-bis(2-hydroxypropyl)toluidine, N,N-bis(3-methacryloyl-2-hydroxypropyl)-p-toluidine, N,N-dibutoxyhydroxypropyl-p-toluidine and 4,4′-bis(dimethylamino)diphenylmethane. Di-iso-propanol-p-toluidine is particularly preferred.

Polymeric amines, such as those obtained by polycondensation of N,N-bis(hydroxyalkyl)aniline with dicarboxylic acids or by polyaddition of ethylene oxide or other epoxides and these amines, are also suitable as accelerators.

Suitable metal salts are, for example, cobalt octoate or cobalt naphthenoate as well as vanadium, potassium, calcium, copper, manganese or zirconium carboxylates. Other suitable metal salts are the tin catalysts described above.

If an accelerator is used, it is used in an amount of from 0.01 to 10 wt. %, preferably from 0.2 to 5 wt. %, based on the reactive resin.

The reactive resin may still contain at least one reactive diluent, if necessary. In this case, an excess of hydroxy-functionalized (meth)acrylate used optionally in the preparation of the backbone resin can act as a reactive diluent. In addition, if the hydroxy-functionalized (meth)acrylate is used in approximately equimolar amounts with the isocyanate group, or in addition if an excess of hydroxy-functionalized (meth)acrylate is used, further reactive diluents may be added to the reaction mixture which are structurally different from the hydroxy-functionalized (meth)acrylate.

Suitable reactive diluents are low-viscosity, radically co-polymerizable compounds, preferably labeling-free compounds, which are added in order to, inter alia, adjust the viscosity of the urethane methacrylate or precursors during its preparation, if required.

Suitable reactive diluents are described in the applications EP 1 935 860 A1 and DE 195 31 649 A1. Preferably, the reactive resin (the resin mixture) contains, as the reactive diluent, a (meth)acrylic acid ester, particularly preferably aliphatic or aromatic C₅-C₁₅ (meth)acrylates being selected. Suitable examples include: 2-hydroxypropyl(meth)acrylate, 3-hydroxypropyl(meth)acrylate, 1,2-ethanediol di(meth)acrylate, 1,3-propanediol dimethacrylate, 1,3-butanediol di(meth)acrylate, 1,4-butanediol di(meth)acrylate, trimethylolpropane tri(meth)acrylate, phenylethyl (meth)acrylate, tetrahydrofurfuryl (meth)acrylate, ethyltriglycol (meth)acrylate, N,N-dimethylaminoethyl (meth)acrylate. N,N-dimethylaminomethyl (meth)acrylate, N,N-diethylaminoethyl (meth)acrylate, acetoacetoxyethyl (meth)acrylate, isobornyl (meth)acrylate, 2-ethylhexyl (meth)acrylate, tert-butylcyclohexyl (meth)acrylate, benzyl(meth)acrylate, methyl(meth)acrylate, n-butyl(meth)acrylate, isobutyl(meth)acrylate, 3-trimethoxysilylpropyl (meth)acrylate, isodecyl(meth)acrylate, diethylene glycol di(meth)acrylate, triethylene glycol di(meth)acrylate, methoxypolyethylene glycol mono(meth)acrylate, trimethylcyclohexyl (meth)acrylate, 2-hydroxyethyl (meth)acrylate, dicyclopentenyloxyethyl (meth)acrylate and/or tricyclopentadienyl di(meth)acrylate, bisphenol-A-(meth)acrylate, novolac epoxy di(meth)acrylate, di-[(meth)acryloyl-maleoyl]-tricyclo-5.2.1.0.2.6-decane, 3-(meth)acryloyl-oxymethyl-tricylo-5.2.1.0.2.6-decane, 3-(meth)cyclopentadienyl (meth)acrylate, and decalyl-2-(meth)acrylate; PEG-di(meth)acrylate such as PEG200 di(meth)acrylate, tetraethylene glycol di(meth)acrylate, solketal (meth)acrylate, cyclohexyl (meth)acrylate, phenoxyethyl di(meth)acrylate, 2-phenoxyethyl (meth)acrylate, hexanediol 1,6-di(meth)acrylate, 1,2-butanediol di(meth)acrylate, methoxyethyl (meth)acrylate, butyl diglycol (meth)acrylate, tert-butyl (meth)acrylate and norbornyl (meth)acrylate. Methacrylates are preferred over acrylates, 2- and 3-hydroxypropyl methacrylate, 1,2-ethanediol dimethacrylate, 1,4-butanediol dimethacrylate, 1,3-butanediol dimethacrylate, glycerol dimethacrylate, trimethylolpropane trimethacrylate, acetoacetoxyethyl methacrylate, isobornyl methacrylate, bisphenol A dimethacrylate, ethoxylated bisphenol A methacrylates such as E2BADMA or E3BADMA, trimethylcyclohexyl methacrylate, 2-hydroxyethyl methacrylate, PEG200 dimethacrylate and norbornyl methacrylate are particularly preferred; a mixture of 2- and 3-hydroxypropyl methacrylate and 1,4-butanediol dimethacrylate, or a mixture of these three methacrylates, is very particularly preferred.

A mixture of 2- and 3-hydroxypropyl methacrylate is most preferred. In principle, other conventional radically polymerizable compounds, alone or in a mixture with the (meth)acrylic acid esters, can also be used as reactive diluents, e.g. methacrylic acid, styrene, α-methylstyrene, alkylated styrenes, such as tert-butylstyrene, divinylbenzene and vinyl and allyl compounds, of which the representatives that are not subject to labelling are preferred. Examples of such vinyl or allyl compounds are hydroxybutyl vinyl ether, ethylene glycol divinyl ether, 1,4-butanediol divinyl ether, trimethylolpropane divinyl ether, trimethylolpropane trivinyl ether, mono-, di-, tri-, tetra- and polyalkylene glycol vinyl ether, mono-, di-, tri-, tetra- and polyalkylene glycol allyl ether, divinyl adipate, trimethylolpropane diallyl ether and trimethylolpropane triallyl ether.

The reactive diluent(s) is/are added in an amount up to 65 wt. %, preferably up to 60 wt. %, more preferably up to 55 wt. %, particularly preferably in amounts below 50 wt. %, based on the reactive resin.

An exemplary reactive resin comprises a compound of general formula (I) as described above

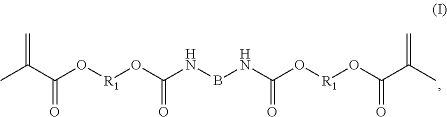

where B is
   (i) a divalent aromatic hydrocarbon group,
   (ii) a divalent aromatic-aliphatic hydrocarbon group, in particular a hydrocarbon group of the formula (Z)

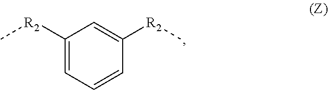

in which R₂ is a divalent branched or linear aliphatic C₁-C₆ alkylene group, or
(iii) a divalent linear, branched or aliphatic hydrocarbon group or an aliphatic hydrocarbon group comprising a cycloaliphatic moiety, and

each R₁ is independently a branched or linear aliphatic C₁-C₁₅ alkylene group, as a backbone resin, a stable nitroxyl radical as an inhibitor, a substituted toluidine as an accelerator and optionally a reactive diluent.

A preferred reactive resin comprises (a) a compound of the formula (II), (111) or (IV)

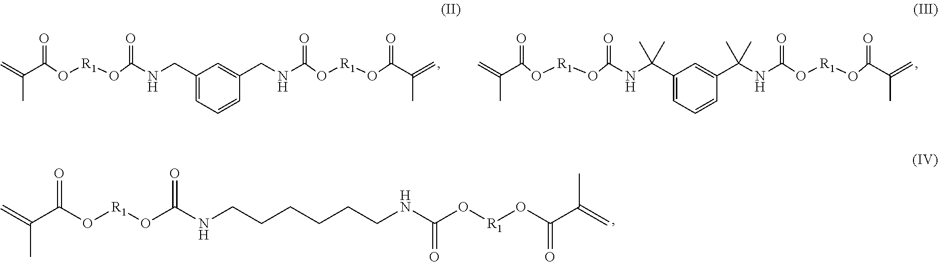

wherein each R₁ is independently a branched or linear aliphatic C₁-C₁₅ alkylene group, as a backbone resin, a stable nitroxyl radical as an inhibitor, a substituted toluidine as an accelerator and optionally a reactive diluent.

A further preferred reactive resin comprises a compound of the formula (V), (VI) or (VII)

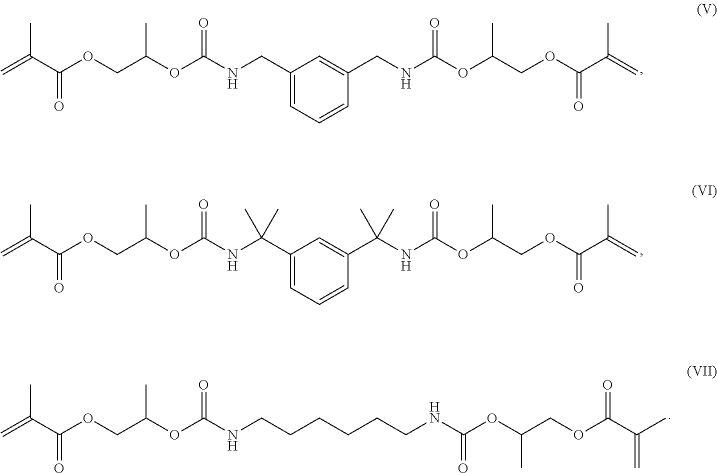

as a backbone resin, a stable nitroxyl radical as an inhibitor, a substituted toluidine as an accelerator, and a reactive diluent.

A particularly preferred reactive resin comprises a compound of formula (V), (VI) or (VII) as a backbone resin, 4-hydroxy-2,2,6,6-tetramethyl-piperdinyl-1-oxyl (TEMPOL) as inhibitor, di-iso-propanol-p-toluidine as accelerator and a mixture of hydroxypropyl methacrylate and 1,4-butanediol dimethacrylate (BDDMA) as a reactive diluent.

A reactive resin just described is obtained for the preparation of a reactive resin component, wherein customary fillers and/or additives are added to the reactive resin. These fillers are typically inorganic fillers and additives, as described below for example.

It should be noted that some substances can be used both as a filler and, optionally in modified form, as an additive. For example, fumed silica is used preferably as a filler in its polar, non-after-treated form and preferably as an additive in its non-polar, after-treated form. In cases in which exactly the same substance can be used as a filler or additive, its total amount should not exceed the upper limit for fillers that is established herein.

The proportion of the reactive resin in the reactive resin component is preferably from approximately 10 to approximately 70 wt. %, more preferably from approximately 30 to approximately 50 wt. %, based on the reactive resin component. Accordingly, the proportion of the fillers is preferably from approximately 90 to approximately 30 wt. %, more preferably from approximately 70 to approximately 50 wt. %, based on the reactive resin component.

This results in the following proportions for the constituents which are or can be present in the reactive resin component: about 2.5 wt. % to about 45.5 wt. %, preferably about 9 wt. % to about 30 wt. %, particularly preferably from about 10 wt. % to about 27 wt. % of compound of general formula (I): up to about 45 wt. %, preferably up to about 40 wt. %, more preferably up to about 30 wt. %, particularly preferably less than 25 wt. % of reactive diluent; from about 0.00005 wt. % to about 1.4 wt. %, preferably from about 0.001 to about 0.7 wt. %, more preferably from about 0.015 to about 0.5 wt. %, and even more preferably from about 0.06% to about 0.25 wt. % of inhibitor; and if an accelerator is used, about 0.001% to about 7 wt. %, preferably about 0.06% to about 2.5 wt. % of accelerator; in each case based on the total weight of the reactive resin component.

The fillers used are conventional fillers, preferably mineral or mineral-like fillers, such as quartz, glass, sand, quartz sand, quartz powder, porcelain, corundum, ceramics, talc, silicic acid (e.g. fumed silica, in particular polar, non-after-treated fumed silica), silicates, aluminum oxides (e.g. alumina), clay, titanium dioxide, chalk, barite, feldspar, basalt, aluminum hydroxide, granite or sandstone, polymeric fillers such as thermosets, hydraulically curable fillers such as gypsum, quicklime or cement (e.g. aluminate cement (often referred to as alumina cement) or Portland cement), metals such as aluminum, carbon black, further wood, mineral or organic fibers, or the like, or mixtures of two or more thereof. The fillers may be present in any desired forms, for example as powder or flour, or as shaped bodies, for example in cylindrical, annular, spherical, platelet, rod, saddle or crystal form, or else in fibrous form (fibrillar fillers), and the corresponding base particles preferably have a maximum diameter of approximately 10 mm and a minimum diameter of approximately 1 nm. This means that the diameter is approximately 10 mm or any value less than approximately 10 mm, but more than approximately 1 nm. Preferably, the maximum diameter is a diameter of approximately 5 mm in diameter, more preferably approximately 3 mm, even more preferably approximately 0.7 mm. A maximum diameter of approximately 0.5 mm is very particularly preferred. The more preferred minimum diameter is approximately 10 nm, more preferably approximately 50 nm, most preferably approximately 100 nm. Diameter ranges resulting from combination of this maximum diameter and minimum diameter are particularly preferred. However, the globular, inert substances (spherical form) have a preferred and more pronounced reinforcing effect. Core-shell particles, preferably in spherical form, can also be used as fillers.

Preferred fillers are selected from the group consisting of cement, silicic acid, quartz, quartz sand, quartz powder, and mixtures of two or more thereof. For the reactive resin component (A), fillers selected from the group consisting of cement, fumed silica, in particular untreated, polar fumed silica, quartz sand, quartz powder, and mixtures of two or more thereof are particularly preferred. For the reactive resin component (A), a mixture of cement (in particular aluminate cement (often also referred to as alumina cement) or Portland cement), fumed silica and quartz sand is very particularly preferred. For the hardener component (B), fumed silica is preferred as the sole filler or as one of a plurality of fillers; particularly preferably, one or more further fillers are present in addition to the fumed silica.

The additives used are conventional additives, i.e. thixotropic agents, such as optionally organically or inorganically after-treated fumed silica (if not already used as a filler), in particular non-polarly after-treated fumed silica, bentonites, alkyl- and methylcelluloses, castor oil derivatives or the like, plasticizers, such as phthalic or sebacic acid esters, further stabilizers in addition to the stabilizers and inhibitors according to the invention, antistatic agents, thickeners, flexibilizers, rheology aids, wetting agents, coloring additives, such as dyes or in particular pigments, for example for different staining of the components for improved control of their mixing, or the like, or mixtures of two or more thereof. Non-reactive diluents (solvents) can also be present, preferably in an amount of up to 30 wt. %, based on the total amount of the reactive resin component, such as low-alkyl ketones, for example acetone, di-low-alkyl low-alkanoyl amides, such as dimethylacetamide, low-alkylbenzenes, such as xylenes or toluene, phthalic acid esters or paraffins, water or glycols. Furthermore, metal scavengers in the form of surface-modified fumed silicas can be present in the reactive resin component. Preferably, at least one thixotropic agent is present as an additive, particularly preferably an organically or inorganically after-treated fumed silica, very particularly preferably a non-polarly after-treated fumed silica.

In this regard, reference is made to the patent applications WO 02/079341 and WO 02/079293 as well as WO 2011/128061 A1.

The proportion of the additives in the reactive resin component may be up to approximately 5 wt. %, based on the reactive resin component.

The reactive resin components obtained by using a compound of the formula (I) according to the invention are commonly used as a reactive resin component of a reactive resin system such as a multi-component system, typically a two-component system of a reactive resin component (A) and a hardener component (B). This multi-component system may be in the form of a shell system, a cartridge system or a film pouch system. In the intended use of the system, the components are either ejected from the shells, cartridges or film pouches under the application of mechanical forces or by gas pressure, are mixed together, preferably by means of a static mixer through which the components are passed, and applied.

An advantage resulting from the use of a compound of formula (I) as described above is an improved thixotropy. This has an effect especially in the application of the composition in boreholes in the wall and in particular in the ceiling, since the compositions after the introduction into the borehole no longer flow and thus do not flow out of the well. This is surprising since it is actually expected that the use of low-viscosity compounds, the viscosity and the dispensing forces of reactive resin components containing these compounds, also tend to cause the composition to flow out after being introduced into the borehole.

Another advantage resulting from the use of a compound of formula (I) as described above is an improved afterflow behavior. This manifests itself by the fact that after the dispension of the composition from the dispenser, less composition afterflow and thus less pollution and less waste occurs.

Therefore, a reactive resin component containing a low-viscosity compound described above is suitable, especially for use in a reactive resin system.

Another object of the present invention therefore also relates to a reactive resin system comprising a reactive resin component (A) and a hardener component (B) containing an initiator for the urethane methacrylate compound.

The initiator is usually a peroxide. Any of the peroxides known to a person skilled in the art that are used to cure unsaturated polyester resins and vinyl ester resins can be used. Such peroxides include organic and inorganic peroxides, either liquid or solid, it also being possible to use hydrogen peroxide. Examples of suitable peroxides are peroxycarbonates (of the formula —OC(O)O—), peroxyesters (of the formula —C(O)OO—), diacyl peroxides (of the formula —C(O)OOC(O)—), dialkyl peroxides (of the formula —OO—) and the like. These may be present as oligomers or polymers.

Preferably, the peroxides are selected from the group of organic peroxides. Suitable organic peroxides are: tertiary alkyl hydroperoxides such as tert-butyl hydroperoxide and other hydroperoxides such as cumene hydroperoxide, peroxyesters or peracids such as tert-butyl peresters, benzoyl peroxide, peracetates and perbenzoates, lauryl peroxide including (di)peroxyesters, perethers such as peroxy diethyl ether, perketones, such as methyl ethyl ketone peroxide. The organic peroxides used as hardeners are often tertiary peresters or tertiary hydroperoxides, i.e. peroxide compounds having tertiary carbon atoms which are bonded directly to an —OO-acyl or —OOH group. However, mixtures of these peroxides with other peroxides can also be used according to the invention. The peroxides may also be mixed peroxides, i.e. peroxides which have two different peroxide-carrying units in one molecule. For curing, (di-benzoyl)peroxide (BPO) is preferably used.

The reactive resin system may be in the form of a two- or multi-component system in which the respective components are spatially separated from one another, so that a reaction (curing) of the components takes place only after they have been mixed.

A two-component reactive resin system preferably comprises the A component and the B component, separated in different containers in a reaction-inhibiting manner, for example a multi-chamber device, such as a multi-chamber shell and/or cartridge, from which containers the two components are ejected by the application of mechanical ejection forces or by the application of a gas pressure and are mixed. Another possibility is to produce the two-component reactive resin system as two-component capsules which are introduced into the borehole and are destroyed by placement of the fastening element in a rotational manner, while simultaneously mixing the two components of the fastening composition. Preferably, in this case a shell system or an injection system is used in which the two components are ejected out of the separate containers and passed through a static mixer in which they are homogeneously mixed and then discharged through a nozzle preferably directly into the borehole.

In a preferred embodiment of the reactive resin system according to the invention, the reactive resin system is a two-component system and the reactive resin component (A) also contains, in addition to the backbone resin, a hydraulically setting or polycondensable inorganic compound, in particular cement, and the hardener component (B) also contains, in addition to the initiator for the polymerization of the backbone resin, water. Such hybrid mortar systems are described in detail in DE 4231161 A1. In this case, component (A) preferably contains, as a hydraulically setting or polycondensable inorganic compound, cement, for example Portland cement or alumina cement, with transition metal oxide-free or transition metal-low cements being particularly preferred. Gypsum can also be used as a hydraulically setting inorganic compound as such or in a mixture with the cement. Component (A) may also comprise silicatic, polycondensable compounds, in particular soluble, dissolved and/or amorphous silica-containing substances such as, for example, polar, non-after-treated fumed silica, as the polycondensable inorganic compound.

The volume ratio of component A to component B in a two-component system is preferably 3:1; 5:1, 7:1 or 10:1, although any other ratio between 3:1 to 10:1 is possible. Particularly preferred is a volume ratio between 3:1 and 7:1.

In a preferred embodiment, the reactive resin component (A) therefore contains:
at least one urethane(meth)acrylate, as defined above; preferably a compound of formula (II), (III) or (IV);
at least one inhibitor of the piperidinyl-N-oxyl or tetrahydropyrrole-N-oxyl type as defined above, preferably TEMPOL;
at least one accelerator as defined above, preferably a toluidine derivative, particularly preferably di-iso-propanol-p-toluidine;
at least one hydraulically setting or polycondensable inorganic compound, preferably cement; and
at least one thixotropic agent, preferably fumed silica,

and the hardener component (B) contains:
at least one initiator for initiating the polymerization of the urethane (meth)acrylate, preferably benzoyl peroxide (BPO) or tert-butyl peroxybenzoate; and
water.

In a more preferred embodiment, the reactive resin component (A) contains:
at least one urethane(meth)acrylate, as defined above; preferably a compound of formula (II), (III) or (IV);
at least one inhibitor of the piperidinyl-N-oxyl or tetrahydropyrrole-N-oxyl type as defined above, preferably TEMPOL;
at least one accelerator, preferably a toluidine derivative, particularly preferably di-iso-propanol-p-toluidine;
at least one hydraulically setting or polycondensable inorganic compound, preferably cement; and
at least one thixotropic agent, preferably fumed silica,

and the hardener component (B) contains:
at least one initiator for initiating the polymerization of the urethane (meth)acrylate, preferably benzoyl peroxide (BPO) or tert-butyl peroxybenzoate;
at least one filler, preferably quartz sand or quartz powder; and
water.

In an even more preferred embodiment, the reactive resin component (A) contains:
at least one urethane(meth)acrylate, as defined above; preferably a compound of formula (II), (III) or (IV);
at least one inhibitor of the piperidinyl-N-oxyl or tetrahydropyrrole-N-oxyl type as defined above, preferably TEMPOL;
at least one accelerator, preferably a toluidine derivative, particularly preferably di-iso-propanol-p-toluidine;
at least one further inhibitor selected from the group consisting of catechols and phenothiazines;
at least one hydraulically setting or polycondensable inorganic compound, preferably cement; and
at least one thixotropic agent, preferably fumed silica,

and the hardener component (B) contains:
at least one initiator for initiating the polymerization of the urethane (meth)acrylate, preferably benzoyl peroxide (BPO) or tert-butyl peroxybenzoate;
at least one filler, preferably quartz sand or quartz powder;
at least one thixotropic agent, preferably fumed silica; and
water.

In an even more preferred embodiment, the reactive resin component (A) contains:
at least one urethane(meth)acrylate, as defined above; preferably a compound of formula (II), (III) or (IV);
at least one inhibitor of the piperdinyl-N-oxyl or tetrahydropyrrole-N-oxyl type as defined above, preferably TEMPOL;
at least one accelerator, preferably a toluidine derivative, particularly preferably di-iso-propanol-p-toluidine;
at least one further inhibitor selected from the group consisting of catechols and phenothiazines;
at least one hydraulically setting or polycondensable inorganic compound, preferably cement;
at least one thixotropic agent, preferably fumed silica, and
at least one further filler, preferably quartz sand,

and the hardener component (B) contains:
Benzoyl peroxide (BPO) or tert-butyl peroxybenzoate as an initiator for initiating the polymerization of the urethane(meth)acrylate;
at least one filler, preferably quartz sand or quartz powder,
at least one thixotropic agent, preferably fumed silica; and
water.

In an even more preferred embodiment, the reactive resin component (A) contains:
at least one urethane(meth)acrylate, as defined above; preferably a compound of formula (II), (VI) or (VII);
TEMPOL;
di-iso-propanol-p-toluidine;
at least one further inhibitor selected from the group consisting of catechols and phenothiazines;
cement;
fumed silica; and
quartz sand,

and the hardener component (B) contains:
at least one initiator for initiating the polymerization of the urethane(meth)acrylate;
fumed silica;
quartz sand or quartz powder and
water.

In each of these embodiments, in a preferred embodiment the reactive resin component (A) additionally contains at least one reactive diluent. This reactive diluent is preferably a monomer or a mixture of a plurality of monomers of the backbone resin.

The reactive resin components (A) and the hardener components (B) in each of these embodiments can be combined with one another as desired.

Such a reactive resin system is used especially in the field of construction (construction purposes), for example for the construction and maintenance or repair of components and structures, e.g. made of concrete, as polymer concrete, as a resin-based coating composition or as a cold-curing road marking, for reinforcing components and structures, such as walls, ceilings or floors, for fastening components, such as slabs or blocks, e.g. made of stone, glass or plastics material, on components or structures, for example by bonding (structural bonding). It is particularly suitable for chemical fastening. It is particularly suitable for (non-positive and/or positive) chemical fastening of anchoring means, such as anchor rods, bolts, rebar, screws or the like, in recesses, such as boreholes, in particular in boreholes in various substrates, in particular mineral substrates, such as those based on concrete, aerated concrete, brickwork, sand-lime brick, sandstone, natural stone, glass and the like, and metal substrates such as steel. In one embodiment, the substrate of the borehole is concrete, and the anchoring means is made of steel or iron. In another embodiment, the substrate of the borehole is steel, and the anchoring means is made of steel or iron. For this purpose, the components are injected into the borehole, after which the devices to be fastened, such as anchor threaded rods and the like, are introduced into the borehole provided with the curing reactive resin and are adjusted accordingly.

The following examples serve to explain the invention in greater detail.

### EXAMPLES

First, reactive resin components and two-component reactive resin systems each containing the compound (V), (VI) or (VII) as a backbone resin were prepared. The dynamic viscosity of the reactive resin components and the rheological behavior of the reactive resin components during and after increased shear were investigated. Furthermore, on a two-component reactive resin system, the amounts of afterflowing material were determined.

Compound (V)

A1. Preparation of the Reactive Resin Masterbatch A1 with Compound (V)

1419 g of hydroxypropyl methacrylate were provided in a 2 liter laboratory glass reactor with an internal thermometer and stirrer shaft and were mixed with 0.22 g of phenothiazine (D Prills; Allessa Chemie), 0.54 g of 4-hydroxy-2,2,6,6-tetramethyl-piperidinyl-1-oxyl (TEMPOL; Evonik Degussa GmbH) and 0.36 g of dioctyltin dilaurate (TIB KAT® 216; TIB Chemicals). The batch was heated to 80° C. Subsequently, 490 g of m-xylene diisocyanate (TCI Europe) were added dropwise while stirring (200 rpm) over 45 minutes. The mixture was then stirred at 80° C. for a further 120 minutes. This produced the reactive resin master batch A1, containing 65 wt. % of the compound (V) as a backbone resin and 35 wt. % of hydroxypropyl methacrylate based on the total weight of the reactive resin master batch.

The compound (V) has the following structure:

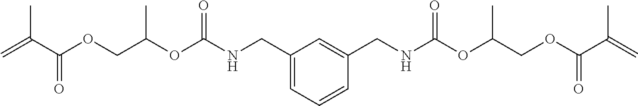 [SMILES: C=C(C)C(=O)OCC(C)OC(=O)NCc1cccc(CNC(=O)OC(C)COC(=O)C(=C)C)c1]

From the reactive resin masterbatch A1, a reactive resin A2 was prepared having a compound (V) as a backbone resin.

A2. Preparation of the Reactive Resin A2

1.08 g of catechol (Catechol flakes; RHODIA), 0.36 g tert-butylpyrocatechol (TBC shed, RHODIA) and 9.2 g di-isopropanol-p-toluidine (BASF SE) were dissolved in a mixture of 160.0 g 1,4-butanediol dimethacrylate (Visiomer 1,4-BDDMA; Evonik Degussa GmbH) and 229.2 g of reactive resin masterbatch from A1.

From the reactive resin A2, a reactive resin component A3 was prepared having compound (V) as a backbone resin.

A3. Preparation of the Reactive Resin Component A3

310.5 g of reactive resin A2 are mixed under vacuum with 166.5 g of Secar® 80 (Kemeos Inc.), 9.0 g of Cab-OSil® TS-720 (Cabot Corporation), 16.2 g of Aerosil® R 812 (Evonik Industries AG), and 397.8 g of quartz sand F32 (Quarzwerke GmbH) in a dissolver with a PC laboratory system dissolver type LDV 0.3-1. The mixture was stirred for 2 minutes at 2500 rpm·min⁻¹, and then for 10 minutes at 4500 rpm·min⁻¹ under vacuum (pressure 5100 mbar) with a 55 mm dissolver disc and an edge scraper. As a result, the reactive resin component A3 was obtained.

A4. Preparation of the Two-Component Reactive Resin System A4

For the preparation of the two-component reactive resin system A4, the reactive resin component A3 (component (A)) and the hardener component (component (B)) of the commercially available product HIT HY 200 (Hilti Aktiengesellschaft, lot number: 8107090) were filled in a plastic cartridge (Ritter GmbH Volume ratio A:B=5:1) having the inner diameters of 32.5 mm (component (A)) and 14 mm (component (B)). As a result, the two-component reactive resin system A4 (for the measurement of the afterflow behavior) was obtained.

Compound (VI)

B1. Preparation of Reactive Resin Masterbatch B1 with Compound (VI)

1179 g of hydroxypropyl methacrylate were provided in a 2 liter laboratory glass reactor with an internal thermometer and stirrer shaft and were mixed with 0.17 g of phenothiazine (D Prills; Allessa Chemie), 0.43 g of 4-hydroxy-2,2,6,6-tetramethyl-piperidinyl-1-oxyl (TEMPOL; Evonik Degussa GmbH) and 0.29 g of dioctyltin dilaurate (TIB KAT® 216; TIB Chemicals). The batch was heated to 80° C. Subsequently, 500 g of 1,3-bis(2-isocyanato-2-propyl)benzene (TCI Europe) were added dropwise with stirring (200 rpm) over 45 minutes. The mixture was then stirred at 80° C. for a further 120 minutes. This produced the reactive resin master batch B1, containing 65 wt. % of the compound (VI) as a backbone resin and 35 wt. % of hydroxypropyl methacrylate based on the total weight of the reactive resin master batch.

The compound (VI) has the following structure:

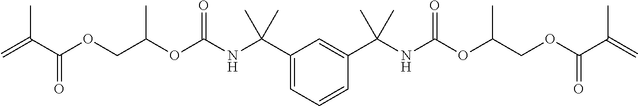 [SMILES: C=C(C)C(=O)OCC(C)OC(=O)NC(C)(C)c1cccc(C(C)(C)NC(=O)OC(C)COC(=O)C(=C)C)c1]

From the reactive resin masterbatch B1, a reactive resin B2 was prepared having a compound (VI) as a backbone resin.

B2. Preparation of the Reactive Resin 12

1.08 g of catechol (Catechol flakes; RHODIA), 0.36 g tert-butylpyrocatechol (TBC shed, RHODIA) and 9.2 g di-isopropanol-p-toluidine (BASF SE) were dissolved in a mixture of 160.0 g 1,4-butanediol dimethacrylate (Visiomer 1,4-BDDMA; Evonik Degussa GmbH) and 229.2 g of reactive resin masterbatch from B1.

From the reactive resin B2, a reactive resin component B3 was prepared having compound (VI) as a backbone resin.

B3. Preparation of the Reactive Resin Component B3

310.5 g of reactive resin B2 are mixed under vacuum with 166.5 g of Secar®80 (Kemeos Inc.), 9.0 g of Cab-OSil® TS-720 (Cabot Corporation), 16.2 g of Aerosil® R 812 (Evonik Industries AG), and 397.8 g of quartz sand F32 (Quarzwerke GmbH) in a dissolver with a PC laboratory system dissolver type LDV 0.3-1. The mixture was stirred for 2 minutes at 2500 rpm·min⁻¹, and then for 10 minutes at 4500 rpm·min⁻¹ under vacuum (pressure 5100 mbar) with a 55 mm dissolver disc and an edge scraper. As a result, the reactive resin component B3 was obtained.

B4. Preparation of the Two-Component Reactive Resin System B4

For the preparation of the two-component reactive resin system B4, the reactive resin component B3 (component (A)) and the hardener component (component (B)) of the commercially available product HIT HY 200 (Hilti Aktiengesellschaft, lot number: 8107090) were filled in a plastic cartridge (Ritter GmbH Volume ratio A:B=5:1) having the inner diameters of 32.5 mm (component (A)) and 14 mm (component (B)). As a result, the two-component reactive resin system B4 (for the measurement of the afterflow behavior) was obtained.

Compound (VII)

C1. Preparation of the Reactive Resin Masterbatch C1 with Compound (VII)

1444 g of hydroxypropyl methacrylate were provided in a 2 liter laboratory glass reactor with an internal thermometer and stirrer shaft and were mixed with 0.23 g of phenothiazine (D Prills; Allessa Chemie), 0.56 g of 4-hydroxy-2,2,6,6-tetramethyl-piperidinyl-1-oxyl (TEMPOL; Evonik Degussa GmbH) and 0.38 g of dioctyltin dilaurate (TIB KAT® 216; TIB Chemicals). The batch was heated to 80° C. Subsequently, 455 g of hexamethylene-1,6-diisocyanate (Sigma Aldrich) were added dropwise with stirring (200 rpm) for 45 minutes. The mixture was then stirred at 80° C. for a further 60 minutes. This produced the reactive resin master batch C1, containing 65 wt. % of the compound (VII) as a backbone resin and 35 wt. % of hydroxypropyl methacrylate based on the total weight of the reactive resin master batch.

The compound (VII) has the following structure:

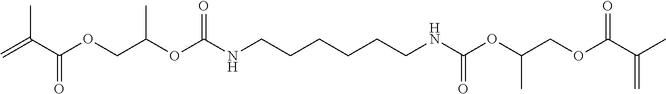 [SMILES: C=C(C)C(=O)OCC(C)OC(=O)NCCCCCCNC(=O)OC(C)COC(=O)C(=C)C]

C2. Preparation of the Reactive Resin C2

1.08 g of catechol (Catechol flakes; RHODIA), 0.36 g tert-butylpyrocatechol (TBC shed, RHODIA) and 9.2 g di-isopropanol-p-toluidine (BASF SE) were dissolved in a mixture of 160.0 g 1,4-butanediol dimethacrylate (Visiomer 1,4-BDDMA; Evonik Degussa GmbH) and 229.2 g of reactive resin masterbatch from C1. The reactive resin C2 was thereby obtained.

From the reactive resin B2, a reactive resin component B3 was prepared having compound (VI) as a backbone resin.

C3. Preparation of the Reactive Resin Component C3

310.5 g of reactive resin C2 are mixed under vacuum with 166.5 g of Secar®80 (Kemeos Inc.), 9.0 g of Cab-OSil® TS-720 (Cabot Corporation), 16.2 g of Aerosil® R 812 (Evonik Industries AG), and 397.8 g of quartz sand F32 (Quarzwerke GmbH) in a dissolver with a PC laboratory system dissolver type LDV 0.3-1. The mixture was stirred for 2 minutes at 2500 rpm·min⁻¹, and then for 10 minutes at 4500 rpm·min⁻¹ under vacuum (pressure≤100 mbar) with a 55 mm dissolver disc and an edge scraper. As a result, the reactive resin component C3 was obtained.

C4. Preparation of the Two-Component Reactive Resin System C4

For the preparation of the two-component reactive resin system C4, the reactive resin component C3 (component (A)) and the hardener component (component (B)) of the commercially available product HIT HY 200 (Hilti Aktiengesellschaft, lot number: 8107090) were filled in a plastic cartridge (Ritter GmbH Volume ratio A:B=5:1) having the inner diameters of 32.5 mm (component (A)) and 14 mm (component (B)). As a result, the two-component reactive resin system C4 (for the measurement of the afterflow behavior) was obtained.

### Comparison Example D

For comparison, a reactive resin masterbatch, a reactive resin and a reactive resin component were prepared as follows with the comparative compound 1.

D1. Preparation of Comparative Reactive Resin Masterbatch D1 with Comparative Compound (I)

The comparative reactive resin masterbatch D1 was prepared with 65 wt. % of comparative compound (I) as the backbone resin and 35 wt. % of hydroxypropyl methacrylate according to the method in EP 0 713 015 A1, which is hereby introduced as a reference and reference is made to the entire disclosure thereof.

The product (comparative compound (I)) has an oligomer distribution, and the oligomer having a repeating unit has the following structure:

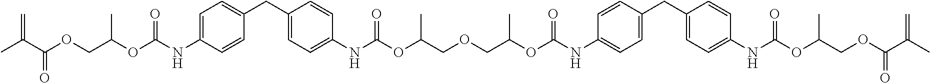

From the comparative reactive resin masterbatch D1, a comparative reactive resin D2 with comparative compound (I) as a backbone resin was prepared.

D2. Preparation of the Comparative Reactive Resin D2

1.08 g of catechol (Catechol flakes; RHODIA), 0.36 g tert-butylpyrocatechol (TBC shed, RHODIA) and 9.2 g di-isopropanol-p-toluidine (BASF SE) were dissolved in a mixture of 160.0 g 1,4-butanediol dimethacrylate (Visiomer 1,4-BDDMA; Evonik Degussa GmbH) and 229.2 g of the comparative reactive resin masterbatch from D1.

From the comparative reactive resin D2, a comparative reactive resin component D3 with comparative compound (I) as a backbone resin was prepared.

D3. Preparation of the Comparative Reactive Resin Components D3

310.5 g of comparative reactive resin D2 are mixed under vacuum with 166.5 g of Secar® 80 (Kemeos Inc.), 9.0 g of Cab-OSil® TS-720 (Cabot Corporation), 16.2 g of Aerosil® R 812 (Evonik Industries AG), and 397.8 g of quartz sand F32 (Quarzwerke GmbH) in a dissolver with a PC laboratory system dissolver type LDV 0.3-1. The mixture was stirred for 2 minutes at 2500 rpm·min⁻¹, and then for 10 minutes at 4500 rpm·min⁻¹ under vacuum (pressure≤100 mbar) with a 55 mm dissolver disc and an edge scraper. As a result, the comparative reactive resin component D3 was obtained.

D4. Preparation of the Comparative Two Component Reactive Resin System D4 For the preparation of the comparative two-component reactive resin system D4, the comparative reactive resin component D3 (component (A)) and the hardener component (component (B)) of the commercially available product HIT HY 200 (Hilti Aktiengesellschaft, lot number: 8107090) were filled in a plastic cartridge (Ritter GmbH Volume ratio A:B=5:1) having the inner diameters of 32.5 mm (component (A)) and 14 mm (component (B)). As a result, the two-component comparative reactive resin system D4 (for the measurement of the afterflow behavior) was obtained.

Determination of Rheological Properties

The influence of the compounds (V), (VI) and (VII) on the viscosity and on the thixotropy of reactive resin components containing these compounds was determined from the dynamic viscosities of the reactive resin components. For this purpose, the dynamic viscosities of the reactive resin components A3, B3 and C3 were measured after different shearing and compared in each case with those of the comparative formulation.

Measurement of the Dynamic Viscosity of the Reactive Resin Components A3. B3 and C3 and of the Comparative Reactive Resin Component D3

The measurement of the dynamic viscosity of the reactive resin components A3, B3 and C3 and the comparative reactive resin component D3 was carried out using a plate-plate measuring system according to DIN 53019. The diameter of the plate was 20 mm and the gap distance was 3 mm. In order to prevent the sample from leaking out of the gap, a limiting ring made of Teflon and placed at a distance of 1 mm from the top plate was used. The measuring temperature was 25° C. The measurement method consisted of three sections: 1. Low shear, 2. High shear, 3. Low shear. In the 1st section, the shear process took place for 3 minutes at 0.5/s. In the 2nd section, the shear rate was logarithmically increased in 8 steps of 15 seconds from 0.8/s to 100/s. The individual stages were: 0.8/s; 1.724/s; 3,713/s; 8/s; 17.24/s; 37.13/s; 80/s; 100/s. The 3rd section was a repetition of the 1st section.

At the end of each section, the viscosities were read. Table 1 shows the value of the second section at 100/s. Three measurements each were made, with the values given in Table 1 being the average of the three measurements.

The thus determined dynamic viscosities of the reactive resin components A3, B3 and C3 were compared with the dynamic viscosities of the comparative reactive resin component D3. The results are summarized in Table 1.

They show that the use according to the invention of the compounds (V), (VI) and (VII) as backbone resin also leads to a lowering of the dynamic viscosity of the reactive resin components prepared therewith at room temperature (23° C.).

Furthermore, the results in table 1 show that after completion of the 2nd measuring section, in which a shear rate of 100 s⁻¹ was used, the reactive resin components reached again a high dynamic viscosity, and the reactive resin components accordingly show a thixotropic behavior. The dynamic viscosity at the end of the 2nd section was so high again that the composition no longer began to flow, such that with these compositions overhead applications are possible without the risk of the compositions flowing out of the borehole. This could be demonstrated in manual experiments in which the two-component reactive resin systems were injected from below into a downwardly open cylinder. All compositions remained in the cylinder. None of the compositions flowed out of the cylinder.

TABLE 1
Results of the measurement of the dynamic viscosities at different shear rates of the reactive resin components A3, B3 and C3
and the comparative reactive resin component D3

| | Reactive resin | Reactive resin | Reactive resin | Comparative reactive |
|---|---|---|---|---|
| | component | component | component | resin component |
| | A3 | B3 | C3 | D3 |
| Dynamic viscosity [Pa · s] | 156.1 | 84.1 | 122.7 | 297.0 |
| at a shear of 0.5 s⁻¹ | | | | |
| (1. section) | | | | |
| Dynamic viscosity [Pa · s] | 5.0 | 4.6 | 4.7 | 12.4 |
| at a shear of 100 s⁻¹ | | | | |
| (2. section) | | | | |
| Dynamic viscosity [Pa · s] | 61.9 | 48.0 | 64.2 | 143.6 |
| at a shear of 0.5 s⁻¹ | | | | |
| (3. section) | | | | |

Determination of the Afterflow Behavior

To determine the afterflow behavior at 0° C. 25° C. and 40° C., the reactive resin systems A4, B4 and C4 and the comparative reactive resin system F4 were tempered to 0° C. or 25° C. and 40° C. The cartridges were manually dispensed with a 5:1 two-component analyzer over a static mixer (HIT RE-M mixer; Hilti Aktiengesellschaft). A preflow of five strokes was discarded. Subsequently, a stroke was dispensed and after the end of the stroke, the dispenser was not unlocked. The composition of material flowing out (afterflowing) after the end of the stroke was determined after curing.

The compositions of afterflowing material of the two-component reactive resin systems A4, B4 and C4, which contain the compounds according to the invention, were mixed with the composition of afterflowing material of the comparative two-component reactive resin system D4, which contains the comparative compound 1, compared at 0° C., at 25° C. and at 40° C.

Five measurements were carried out respectively. The measurement results are summarized in Table 2.

TABLE 2
Results of the measurement of the amounts of afterflowing material in the
reactive resin systems A4, B4 and C4 and the comparative reactive resin system D4

| Two-component | | | |
|---|---|---|---|
| reactive resin | Composition of afterflowing material in g | | |
| system | 0° C. | 25° C. | 40° C. |
| A4 | 0.63 | 0.03 | 0.91 |
| B4 | 0.76 | 0.86 | 0.61 |
| C4 | 0.29 | 0.25 | 0.45 |
| D4 | 1.95 | 1.11 | 1.26 |

The results in Table 2 clearly show that, despite the lower viscosity of the reactive resin components A3. B3 and C3 over the comparative reactive resin component D3 and the lower high shear viscosity (100 s⁻¹) (see data from Table 1), the systems containing the compounds (V), (VI) and (VII) as a backbone resin are much less prone to afterflowing over the entire temperature range than the systems containing the comparative compound (I) as a backbone resin.

1: A reactive resin component for chemical fastening, comprising:
a compound of the general formula (I) 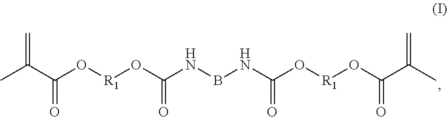
wherein B is
(i) a divalent aromatic hydrocarbon group,
(ii) a divalent aromatic-aliphatic hydrocarbon group, or
(iii) a divalent linear, branched or cyclic aliphatic hydrocarbon group, or an aliphatic hydrocarbon group comprising a cycloaliphatic moiety, and
wherein each R₁ is independently a branched or linear aliphatic C₁-C₁₅ alkylene group.

2: The reactive resin component according to claim 1, wherein B is an aromatic C₆-C₂₀ carbon group.

3: The reactive resin component according to claim 1, wherein B is (i) an optionally substituted benzene ring, two optionally substituted fused benzene rings or two optionally substituted benzene rings which are bridged via an alkylene group.

4: The reactive resin component according to claim 1, wherein B is (ii) a divalent aromatic-aliphatic hydrocarbon group of formula (Z) 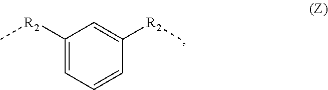
in which R₂ is a divalent branched or linear aliphatic C₁-C₆ alkylene group.

5: The reactive resin component according to claim 1, wherein B is (iii) a divalent linear or branched aliphatic C₅-C₈ hydrocarbon group.

6: The reactive resin component according to claim 1, wherein B is (iii) an aliphatic hydrocarbon group (Y) comprising a cycloaliphatic moiety, 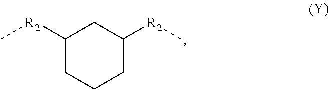
in which R₂ is a divalent branched or linear aliphatic C₁-C₆ alkylene group.

7: The reactive resin component according to claim 1, wherein the compound of general formula (I) is a compound of formula (II), (III) or (IV) 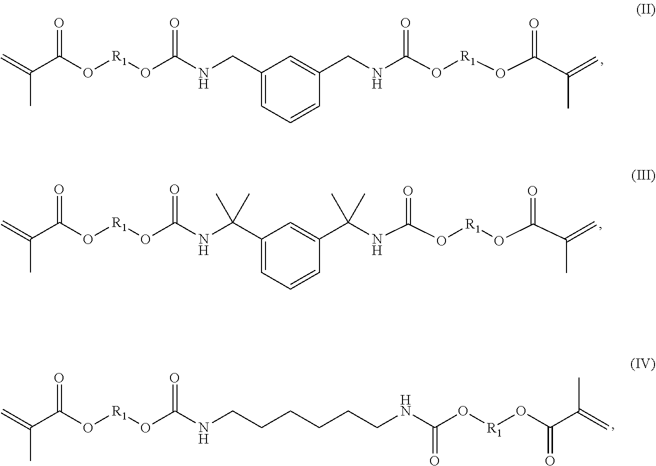
wherein each R₁ is independently a branched or linear aliphatic C₁-C₁₅ alkylene group.

8: The reactive resin component according to claim 1, wherein R₁ is a C₂- or C₃-alkylene group.

9: The reactive resin component according to claim 1, wherein the compound of general formula (I) is a compound of formula (V), (VI) or (VII)

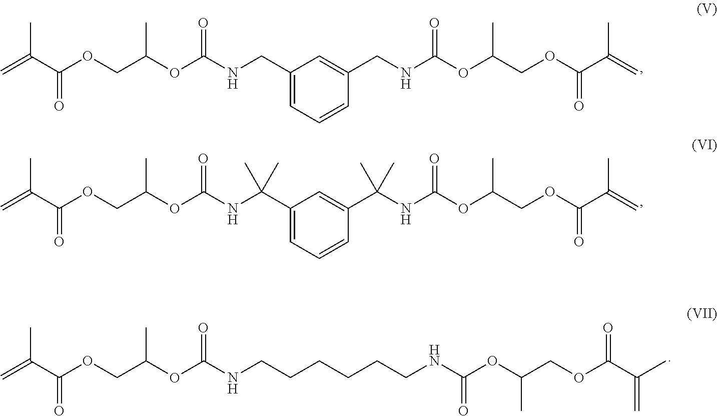

10: The reactive resin component according to claim 1, wherein the reactive resin component comprises at least one inhibitor, at least one accelerator, and optionally at least one reactive diluent.

11: The reactive resin component according to claim 10, wherein the reactive resin component further comprises an organic and/or inorganic filler and/or additive.

12: The reactive resin component according to claim 1, wherein a proportion of the compound of general formula (I) in the reactive resin component is about 2.5 wt. % to about 45 wt. %, based on the reactive resin component.

13: A two-component system, comprising the reactive resin component according to claim 1.

14: A multi-component system, comprising the reactive resin component according to claim 1.

15: A method, comprising:
preparing the reactive resin component according to claim 1.
